(19) United States
(12) Patent Application Publication
(10) Pub. No.: US 2009/0098303 A1
(43) Pub. Date: Apr. 16, 2009

(54) Coatings to increase water and grease resistance of porous materials and materials having such protection

(75) Inventors: Christopher B. Murphy, Woodridge, IL (US); Jon O. Fabri, Charleston, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: Polymer Ventures, Inc., Charleston, SC (US)

(21) Appl. No.: 11/974,615

(22) Filed: Oct. 15, 2007

(51) Int. Cl. C08L 91/06; B05D 7/00

(52) U.S. Cl. 427/416; 106/270

(57) ABSTRACT

A method of improving gas, water, water vapor, and/or grease resistance of a porous material is disclosed which comprises treating th(e material with a wax, poly(vinyl alcohol), plasticizer, and optionally a polyamine. In some embodiments, an optional first treatment agent may be applied to the material prior to the application of wax and poly(vinyl alcohol), plasticizer, and optionally a polyamine. Materials that have a single coating of wax, poly(vinyl alcohol), plasticizer, and optionally a polyamine, as well as materials having a multi-layer coating that includes a first coating of a first treatment agent and a second coating of wax, poly(vinyl alcohol), plasticizer, and optionally a polyamine are also disclosed.

### BACKGROUND OF THE INVENTION

The present invention relates to methods to impart grease resistance and/or water resistance to materials, and more particularly to methods of improving grease resistance and/or water resistance that reduce or replace the use of fluorochemical compounds and involve two or more treatment agents, while maintaining the grease and/or water resistance upon folding or creasing of treated materials.

Materials, such as paper and textiles, are commonly treated or coated to improve their resistance to liquids such as water, grease and oil. Commercial compounds such as SCOTCHGARD™® and SCOTCHBAN®, both products of Minnesota Mining and Manufacturing Co. have been widely used to improve the barrier properties of papers, textile fabrics, nonwoven fabrics, upholstery, carpet fibers, and the like.

SCOTCHGARD™® and SCOTCHBAN®, and similar products, contain fluorochemicals, which have recently become the object of health and environmental concerns because of their persistence and tendency to bioaccumulate. Consequently, there is strong interest in replacing or reducing the use of fluorochemical compounds such as perfluorooctane sulfonate (PFOS), perfluorooctanoate (PFOA), polytetrafluoroethylene (PTFE), perfluoro-n-decanoic acid (PFDA) and other perfluorinated compounds that are widely used for imparting grease, oil, and/or water resistance to the substrates to which they are applied.

Recently several products have been introduced into the marketplace as potential replacements for the fluorochemical compounds. These materials are based on inorganic materials like silicone and on organic polymers, or combinations of those materials. However, to dale, these replacements have fallen short of the cost/performance standards established by the fluorinated compounds in this area of use.

### SUMMARY OF THE INVENTION

Briefly, therefore the present invention is directed to a novel method of improving grease and/or water resistance of a material, the method comprising treating the material with wax, poly(vinyl alcohol), arid a plasticizer for imparting flexibility to the coatings.

The present invention is also directed to a novel composition for improving grease and/or water resistance of a material, the composition comprising wax, poly(vinyl alcohol), and a plasticizer for imparting flexibility to the coatings.

The present invention is also directed to a novel material that has been treated with a composition comprising poly(vinyl alcohol), wax, and a plasticizer.

The present invention is also directed to a novel material that has been treated with poly(vinyl alcohol), wax, a polyamine, and a plasticizer.

The present invention is also directed to a novel material that substantially maintains grease resistance and/or water resistance after being folded and/or creased.

The present invention is also directed to a novel method of improving the gas, water, water vapor, or grease resistance of a porous material, the method comprising: applying to the porous material a first treatment agent; and after the first treatment agent has been applied to tile porous material, applying to a surface of the porous material wax, poly(vinyl alcohol), a plasticizer, and optionally a polyamine, thereby improving the gas, water, water vapor, or grease resistance of the porous material, as well as the flexibility of the coated porous material.

The present invention is also directed to a novel porous material having improved gas, water, water vapor and/or grease resistance comprising the porous material having a surface on which is a first coating of a first treatment agent and a second coating comprising wax, poly(vinyl alcohol), a plasticizer, and optionally a polyamine over the first coating.

The present invention is also directed to a novel porous material that has been treated by the method described above.

Among the several advantages found to be achieved by the present invention, therefore, may be noted the provision of compounds and methods that effectively improve the grease and/or the water resistance of a material and which are cost effective and easy to apply. She provision of such compounds and methods that are more environmentally benign than the current fluorochemical compounds, the provision of such compounds and methods that require reduced amounts of, or are free of fluorochemical compounds, and the provision of such compounds and methods impart improved flexibility and grease and/or water resistance at the location of a fold or crease of a coated material.

### DETAILED DESCRIPTION OF THE PREFERRED EMBODIMENTS

In accordance with the present invention, it has been discovered that treatment of materials, such as paper, with a combination of wax, poly(vinyl alcohol), and a plasticizer greatly improves the grease and water resistance of the materials. In preferred embodiments, the degree of improvement is more than would have been expected based merely on the additive effect of the combination.

In tests with uncoated paper, coating with wax or poly(vinyl alcohol) alone provided grease resistance (reported as Flat Kit numbers measured according to TAPPI TEST METHOD T-559 “Grease Resistance for Paper and Paperboard”) of from about 1-3, even at dosage rates of up to 0.624 lbs total dry substance per 3000 ft² of paper (lb. d.s./3000 ft²). In contrast, however, treatment with a combination of paraffin wax and poly(vinyl alcohol) provided protection levels of Flat Kit number 4, even at a dosage as low as 0.156 lb d.s./3000 ft², and protection of Flat Kit number 5 at 0.468 lbs d.s./3000 ft², and Flat Kit number 6 at 0.624 lbs d.s./3000 it².

As used herein, the term “Flat Kit” shall be understood as, referring to the Kit number when the coated material has not been subjected to folds, creases, or other mechanical stresses.

In accordance with the present invention, it has also been discovered that treatment of porous materials, such as paper, with an optional first treatment agent, such as a conventional polymer latex/filler surface coating, followed by a treatment with wax, poly(vinyl alcohol), a plasticizer, and optionally a polyamine, greatly improves the gas, water, water vapor, and/or grease resistance of the materials, even at relatively low levels of the second treatment. In preferred embodiments, the degree of improvement is more than would have been expected based merely on the additive effect of the two treatments.

The intent of the invention is that the first treatment step is an optional step, and the first treatment agent is an optional agent. Accordingly, as used herein, reference to the second treatment step, second treatment agent, and/or the second coating will be understood a, being the only treatment step or coating when the first treatment step or coating is absent in accordance with the intent of the invention.

In tests with 190# whiteboard, a commercial coating of a polymer latex and filler provided grease resistance (reported as Flat Kit numbers measured according to TAPPI TEST METHOD T-559 “Grease Resistance for Paper and Paperboard”) of about zero (0), but treatment of the coated whiteboard with a wax/poly(vinyl alcohol)/polyamine/plasticizer coating, even at dosage rates of under 10 lbs. d.s./ton of paper, improved Flat Kit numbers to about 5, while application of under 15 lbs. d.s./ton improved Flat Kit numbers to about 8, and under 20 lbs. d.s./ton improved Flat Kit numbers to about 12.

Another feature of the present invention is that such superior performance can be obtained without the use of higher, and more expensive, grades of poly(vinyl alcohol). It has been shown that the present methods can be carried out successfully with less expensive grades of poly(vinyl alcohol), such as partially hydrolyzed and intermediate hydrolyzed poly(vinyl alcohol), and that the use of higher grades, such is fully hydrolyzed or super hydrolyzed, is not required. This feature is highly advantageous in controlling the expense of the coating procedure, and improves the cost effectiveness of the innovative method.

In a further embodiment, the inventors have found that the addition of a polyamine to the combination of wax and poly(vinyl alcohol) provides additional improvement in the performance of the compositions. For example, a combination of paraffin wax, poly(vinyl alcohol), and dicyandiamide-formaldehyde condensate provided protection levels of Flat Kit number 7 at dosage rates of 0.468 lbs d.s./3000 ft².

When the present specification refers to an improvement in the gas, water, water vapor, and/or grease resistance of a porous material, what is meant is any increase, no matter how small, in the resistance of the porous material to penetration by any type of gas, water, water vapor and/or grease. The term “grease”, as used herein, refers to any type of oil, fat, or lipid, whether natural or synthetic, and includes without limitation, natural fats and oils, such as seed oils, including corn oil, soybean oil, rapeseed oil, sunflower oil, and the like, lard, animal fats, and synthetic oils, such as silicone oil and the like, and also liquid, semi-solid and solid hydrocarbons.

In an embodiment of the invention, improving the gas, water, water vapor, or grease resistance of the porous material comprises increasing the grease resistance of the porous material as measured by Kit number, where the wax, poly(vinyl alcohol), plasticizer and optional polyamine are applied in an amount sufficient to improve the grease resistance by at least 3 Kit numbers. In another embodiment, improving the gas, water, water vapor, or grease resistance of the porous material comprises increasing the grease resistance of the porous material as measured by Kit number, where the wax, poly(vinyl alcohol), plasticizer, and optional polyamine are applied in an amount sufficient to improve the grease resistance by at least a factor of 2 but no less than 2 Kit numbers;.

In the present specification, the term “coating” is not intended lo be limiting to a surface coating, unless that is explicitly stated. By way of example, a coating of the first treatment agent can be applied by adding the first treatment agent to the wet end of a paper machine. The first treatment agent, therefore, is distributed throughout the depth of the paper, but such application is still embraced by the term “coating”, as used herein. On the other hand, the terms “surface coating” are meant to refer to a coating that is applied to the outer surface of a porous material, such as a spray or roll coating applied to a dry paper web.

In an embodiment of the present method, the first treatment agent can be any treatment agent that is known for use in sizing, increasing water resistance, gas resistance, water vapor resistance, wet strength, dry strength, softness, drape, hand, and/or the printability of a porous material, except those agents that are not compatible with a subsequent treatment comprising wax, poly(vinyl alcohol), and plasticizer, optionally with a polyamine.

The first treatment agent can be applied during the formation or manufacture of the porous material, such as at the wet end of a paper machine. Preferably, however, the first treatment agent is applied to a surface of the porous material after the material has been formed. An example of this is the application of the first treatment agent as a coating on paper at the dry end of the paper machine, or at any time after formation of the paper web.

The first treatment agent can be provided in the form of a waterborne coating formulation or a solvent-borne coating formulation. Commonly, the first treatment agent comprises a polymer binder. The polymer can be applied neat, as in a hot melt roll application (such as is used for the application of a polyethylene wax to paperboard for the manufacture of milk cartons), or it can be applied as a solution or in a dispersion as a latex. It is common that the polymer is dispersed as a waterborne latex due to the low toxicity, safety and low organic emissions of the application process.

Examples of polymers that are useful as the polymer binder of the first treatment agent include poly(vinyl alcohol), polyacrylate, polystyrene/polyacrylic copolymer, cellulose derivative, nitrocellulose, vinyl chloride, vinyl chloride copolymers, vinyl acrylate copolymers, vinyl acerbate homopolymers, vinyl acetate copolymers, styrene butadiene polymers, styrene butadiene acrylonitrile polymers, polyvinylacetate, proteins, milk proteins, starch, and mixtures of any of these.

In one embodiment, the first treatment agent can include wax, poly(vinyl alcohol), plasticizer, and optionally a polyamine. In other words, it can be the same as, or similar to the composition that is used in the subsequent wax/poly(vinyl alcohol)/plasticizer and optional polyamine treatment.

The first treatment agent can have additional components and common additional components can include pigments, such as natural or synthetic pigments; minerals, such as calcium carbonate, titanium dioxide, Kaolin clay, Montmorillionite clay, and gypsum; organic opacifiers; lubricants; surface sizes, such as starch; saturants; release coatings; rheology modifiers; dispersants; insolubilizers; or plasticizers, such as dioctyl phthalate, tricresyl phosphate, and castor oil. The first treatment agent can include any of these materials and any mixtures thereof. In some embodiments, latex binders with inorganic fillers, as described above, are preferred.

The first treatment agent is applied in any amount that will achieve the beneficial effects described above. However, in some embodiments, it is preferred that the first treatment agent is applied in an amount of from about 0.1 to about 50 g/m². It is more preferred that the amount of the first treatment agent to be applied is from about 1 to about 30 g/m², and an amount of from about 2 to about 20 g/m² is even more preferred.

Many commercially available materials may be used as the first treatment agent. These include products marketed under the tradenames of RHOPLEX, POLYCO, ROPAQUE, ACUMER and TAMOL, all available from RohmNova, Mogadore, Ohio.

It should be noted that the present invention embraces the embodiment where the step of applying the first treatment agent is done by another. In other words, the first step of applying the first treatment agent is intended to embrace the act of selecting a pre-coated porous material, to which one can then apply the wax/poly(vinyl alcohol) and optional polyamine.

Although the present invention offers an advantage of providing superior water and grease resistance with the use of coatings that are free of fluorochemical compounds, the invention also embraces the situation where a reduced amount of a typical fluorochemical water, oil and/or grease proofing agent, such as perfluorooctane sulfonate (PFOS), perfluorooctanoate (PFOA), polytetrafluoroethylene (PTFE), perfluoro-n-decanoic acid (PFDA), or the like, is used in conjunction with the present method to obtain superior Kit numbers. The conventional fluorochemical agent can be applied prior to the present method, or is optionally applied as the first treatment agent, and the second treatment agent is then applied to provide superior levels of grease and/or oil and water resistance. When it is said that a reduced amount of a typical fluorochemical agent is used, it is meant that at least 10% less of the fluorochemical agent is used than would otherwise be required to obtain the Kit number that is achieved when the fluorochemical agent is used in conjunction with the present method. Preferably, the amount of the fluorochemical agent is 25% less, more preferably 50% less than would be required without the use of the novel method.

In the present method, after the application of the first treatment agent to the porous material (or the selection of a porous material having had a first treatment agent applied to it), wax, poly(vinyl alcohol), plasticizer, and optionally a polyamine is applied to a surface of the porous material, thereby improving the gas, water, water vapor, or grease resistance of the porous material.

Any suitable poly(vinyl alcohol) can be used in the present methods and compositions. Poly(vinyl alcohol) is a polymer comprising vinyl acetate monomer units, some of which have been hydrolyzed to yield alcohol functional groups on the polymer. Poly(vinyl acetate) and poly(vinyl acetate-co-vinyl alcohol) are also included in the definition of poly(vinyl alcohol). The polymer can contain other co-monomers such as ethylene, propylene, butylene, ethylene oxide, propylene oxide, and the like without departing from the scope of the invention. The poly(vinyl alcohol) can be in the physical form of a solid, an emulsion, a suspension, or a liquid solution.

The physical properties of poly(vinyl alcohol) are controlled by molecular weight and the degree of hydrolysis, and a wide range of commercial grades is offered by poly(vinyl alcohol) manufacturers. Some of the commercially available grades of poly(vinyl alcohol) are: Partially Hydrolyzed, Intermediate Hydrolyzed, Fully Hydrolyzed, and Super Hydrolyzed. The molecular weight depends on the conditions of polymerization, and the degree of hydrolysis is defined as the percent of acetate groups replaced by hydroxyl groups during the hydrolysis reaction. The specific gravity of poly(vinyl alcohol) solutions depends on concentration and temperature and is independent of grade. Poly(vinyl alcohol) reacts in a manner similar to secondary alcohols.

The poly(vinyl alcohol) employed in accordance with this invention may be any grade poly(vinyl alcohol) that is compatible with paraffin waxes and optionally with polyamines such as dicyandiamide-formaldehyde condensate and that provides improved grease resistance or improved water resistance, or both, when applied to a material, such as paper, in combination with paraffin wax and optionally a polyamine.

In a preferred embodiment, the poly(vinyl alcohol) component comprises a partially hydrolyzed poly(vinyl alcohol), typically having a percent hydrolysis of about 87%-89% and a viscosity of about 45-55 centipoise (4% aqueous solution at 20° C.).

The manufacture of poly(vinyl alcohol) involves starting with polyvinyl acetate and converting that material to poly(vinyl alcohol) generally by base-catalyzed methanolysis. Polyvinyl acetate polymerization is done by conventional processes such as, for example, solution, bulk or emulsion polymerization. The polymerization step controls the ultimate molecular weight of the poly(vinyl alcohol). Catalyst selection, temperature and solvent control the degree of polymerization.

The degree of hydrolysis of poly(vinyl alcohol) is controlled during the alcoholysis reaction and is independent of molecular-weight control. Fully hydrolyzed poly(vinyl alcohol) is obtained if methanolysis is allowed to go to completion. The reaction can be terminated by neutralizing or removing the sodium hydroxide catalyst. The addition of small amounts of water to the reactants promotes saponification of polyvinyl acetate, which consumes sodium hydroxide. The extent of hydrolysis is inversely proportional to the amount of water added. Typical degrees of hydrolysis of commercial grades of poly(vinyl alcohol) are: Super Hydrolyzed (over 99.3%), Fully Hydrolyzed (98.0-98.8%), Intermediate Hydrolyzed (91.0-96.5%, with range varying by molecular weight), and Partially Hydrolyzed (86.0-89.0, with range varying by molecular weight).

An example of a commercially-available poly(vinyl alcohol) which is partially hydrolyzed and which is suitable for use in the present invention is CELVOL 840, which is available from Celanese Corporation of Dallas, Tex.

In the present invention, the poly(vinyl alcohol) can be used neat, or it can be used in combination with a defoamer. It is not uncommon to add a defoamer when using an intermediate or partially hydrolyzed grade or poly(vinyl alcohol).

Any wax can be used in the methods and compositions of the present invention. Useful waxes may be natural or synthetic, or combinations thereof, and may be macrocrystalline or microcrystalline. The wax can be obtained from animal, vegetable or mineral sources, or it may be produced synthetically. Useful waxes generally have melting points within the range of about 20° C. to about 200° C., and include animal waxes, mineral waxes, vegetable waxes, insect waxes, and synthetic waxes including: beeswax; bayberry-myrtle; candelilla; caranday; carnauba; castor bean wax; esparto grass wax; Japan wax; montan crude wax; ouricury; retamo-ceri nimbi; shellac wax; spermaceti; sugar cane wax; and wool wax-lanolin.

Of these waxes, petroleum waxes and synthetic waxes are exemplary for the methods and compositions of the present invention. Paraffins and chlorinated paraffin waxes also are of interest as the wax components of the present methods and compositions, as are waxes produced by the emulsion polymerization of ethylene, styrene, or acrylates (weight average molecular weights of about 10,000 to about 50,000). Oxidized hydrocarbon waxes, such as those manufactured from the Fisher-Tropsch paraffins, and the microcrystalline petroleum waxes (ester type waxes) also are useful in the methods and compositions of the present invention.

Other synthetic waxes of entirely different structure such as the fatty amides, fatty imides, fatty amines, including stearylated melamine, and fatty nitrites can be waxlike and can be used in the present invention. The polyoxyethylenes or carbowaxes are an important group of waxes because of their solubility properties and compatibility with fatty materials.

The petroleum waxes, particularly paraffin waxes but also the microcrystalline waxes are particularly preferred for use in the present invention. The petroleum waxes are predominantly long chain (C₁₆-C₅₀) alkane compounds. The paraffins are mostly straight-chain molecules, but may have branched claims. The microcrystalline waxes range in molecular weight from about 400 to about 700 and have average molecules of about 40 to about 50 carbon atoms. The microcrystalline waxes have more branched-chain molecules than in paraffin waxes, containing an average of three carbon atoms per side chain. Oxidized microcrystalline waxes also are useful in the compositions of the present invention. Petroleum waxes contain both solid and liquid hydrocarbons with the liquid hydrocarbons held in discrete droplets within the petroleum wax. The paraffin waxes used in the compositions of the present invention may be crude scale wax and/or fully refined wax.

Synthetic paraffin waxes are mixtures of saturated straight-chain paraffinic hydrocarbons with short side chains (C₁-C₄). The weight average molecular weight is about 700 to about 800 or about 45-60 carbon atoms per molecule.

Paraffin wax is a preferred wax for use in the present invention. Any type or grade of paraffin wax can be used in the present invention that is compatible with poly(vinyl alcohol) and optionally with a polyamine, and that provides improved resistance to grease or improved resistance to water, or both, when applied to a material such as paper in combination with poly(vinyl alcohol) and optionally with a polyamine such as dicyandiamide-formaldehyde condensate.

Preferred paraffin waxes are unbranched or sparsely branched waxy white or colorless solid hydrocarbon mixtures that can be used to make candles, wax paper, lubricants, and sealing materials. The chemical composition of a preferred paraffin wax is a mixture of predominantly non-aromatic saturated hydrocarbons with the general formula CₙH₍₂ₙ₊₂₎ where n is preferably an integer between 12 and 50, and more preferably between 22 and 27. It is preferable that the paraffin has a melting point, or melting point range, between about 25° C. and about 200° C., more preferably between about 47° C. and 95° C., and yet more preferably between about 47° C. and abut 65° C., and is insoluble in water. An example of a preferred paraffin wax is available from Sigma-Aldrich, Milwaukee, Wis., as Cat. No. 31,765-9, having a CAS RN of 8002-74-2, and a melting point range of 52°-58° C.

Other organic materials can be used with, or added to, the wax without departing from the scope of the invention. For example, when the wax is to be used as an aqueous emulsion, it is common to add an emulsifier to the mixture to stabilize the emulsion. A commonly used emulsifier for this purpose is a styrene-acrylate copolymer. Another commonly used material is MOREZ 101 (a butyl acrylate methyl-methacrylate copolymer available from Rohm & Haas). The wax, water, and the emulsifier can be intermixed with high shear to form a stable emulsion, which can then be used in suitable amounts to produce the compositions of the present invention.

In some embodiments, it is preferred that paraffin wax and poly(vinyl alcohol) be the only materials present that have a significant effect on the grease and/or water resistance of the material. This is advantageous in circumstances where it is desirable to limit the cost or complexity of the treatment. In this instance, the treatment and compositions are said to consist essentially of poly(vinyl alcohol) and paraffin wax.

In at least one embodiment, plasticizers may be added to the present composition to impart improved flexibility to the coating and improve the Fold Kit value of the coated material. As used herein, the term “Fold Kit value” encompasses the Kit Value of the coated material at or near the location of a fold or crease in the coated material.

Those having ordinary skill in the art will recognize that typical grease resistant and/or water resistant coatings tend to display at least some level of brittleness, or a tendency to crack, when folded or creased. These cracks may lead to decreased grease and/or water resistance at or near the location of the cracks. Similarly, the presence of cracks in the coating layer(s) may enable migration of grease and/or water under the coatings to other areas of the coated material, further degrading the grease and/or water resistance of the coated material.

Plasticizers contemplated as useful in accordance with the present invention include plasticizers that impart improved flexibility and improved Fold Kit values. Exemplary plasticizers include traditional plasticizers, such as phthalate esters, but polymeric plasticizers are preferred. Exemplary polymer plasticizers are one or more of polybutene, polyisobutylene, polybutene-1, polybutadiene, polyisoprene, and natural rubber latex. Also contemplated as useful are homopolymers and copolymers formed from one or more of butene, isobutylene, butadiene, and isoprene. Comonomers can include one or more of styrene, acrylic acid, acrylamide, acrylonitrile, acrylate esters, ethylene, propylene, vinyl acetate, vinyl formamide, and cationic comonomers.

Exemplary plasticizers include homopolymers of butene, which has been found to improve flexibility and Fold Kit values without sacrificing the standard (flat) Kit values. Homopolymers of butene are commercially available from companies such as Ineos Oligomers, Shell, Basell, and others.

The plasticizer may be added to the coating compositions in any amount effective to improve the Fold Kit value. Exemplary embodiments, may include adding the plasticizer in an amount that is about 10 to about 70% by weight, based on the weight of the wax component. In other embodiments, the plasticizer may be added in an amount that is about 20 to about 50% by weight based on the wax component.

Improvements in flexibility impart improved grease and/or waiter resistance to the coated materials when they are folded, creased, or otherwise mechanically stressed. While the previous grease resistance technology of fluorochemicals acts by changing surface tension, the present grease and/or water resistant coatings of the present invention act as a barrier coating. When barrier coating materials that impart grease and/or water resistance are folded, creased, or otherwise mechanically stressed, a crack can occur and cause imperfections in the grease and/or water resistant properties, as discussed above. The Fold test is used to measure grease resistance of a treated material at the site of a fold and a higher Fold Kit value, as previously discussed, represents an improvement in grease and/or water resistance.

Improved flexibility also increases the coefficient of friction of the present coatings. In general, waxes have a low coefficient of friction, and materials coated with wax containing compositions can be difficult to handle due to slippage on machinery. The present grease and/or water resistant coatings have a higher coefficient of friction, resulting in improved handling of coated materials.

Additionally, and unexpectedly, the present coatings including a plasticizer have improved transparency over coatings not including plasticizers.

Optionally, a polyamine can be included as a component of the wax/poly(vinyl alcohol)/polyamine coating. The preferred polyamine is an amine-aldehyde condensate that is the reaction product of an amine containing an active hydrogen atom and an aldehyde. Examples of the amine include guanidine, urea, dicyandiamide, melamine, aniline, ethylenediamine, diethylenetriamine, monoethanolamine, diethanolamine, polyoxyalkyleneamines, polyoxyalkylenediamines, polyoxyalkylenetriamines, and the like. Examples of the aldehyde include formaldehyde, acetaldehyde, glutaraldehyde, glyoxal, hexamethylenetetramine, and paraformaldehyde. Accordingly, examples of polyamines that are useful in the present invention include a condensation product of any one or more of the amines listed above with any one or more of the aldehydes listed above. Polyamines that are useful in the present invention also include, without limitation, polyoxyalkyleneamines, polyoxyalkylenediamines, polyoxyalkylenetriamines, and mixtures of any of these. Examples of these materials include the JEFFAMINE® series of polyoxyalkyleneamines available from Huntsman Corporation, The Woodlands, Tex.

The reaction between the amine and aldehyde is usually conducted in aqueous solution and can be done at acid, neutral, or alkaline pH. The preferred condition is acid pH. Additional information regarding the production of suitable dicyandiamide-formaldehyde condensates can be found, for example, in U.S. Pat. No. 3,957,574 to Anderson.

A preferred polyamine for the present invention is a dicyandiamide-formaldehyde condensate. Examples of polyamines that are considered to be dicyandiamide-formaldehyde condensates, and which are useful in the invention are available from Polymer Ventures, Inc., Charleston, S.C., as RD111-013 and PC-540. RD111-013 is an acid condensation product of dicyandiamide, urea, and formaldehyde, and is available as a clear viscous solution of 46% d.s. having a viscosity of 50-250 cps and a pH of about 5.5. It is cationic and has a density of about 10 lbs/gal. PC-540 is an acid condensation product of dicyandiamide, urea, and formaldehyde and is available as a clear viscous solution of 50% d s. having a viscosity of 10-100 cps and a pH of about 3.5. It is cationic and has a density of about 10 lbs/gal. Either of these polyamines can be used as commercially supplied.

Polyamines, and dicyandiamide-formaldehyde condensates in particular, are described in U.S. Pat. No. 6,576,086 by Ettl et al. as being useful as fixing agents in the production of paper or paperboard during paper stock draining. Similar materials are also discussed by Anderson in U.S. Pat. No. 3,957,574 as being preferred dye fixatives in a paper sizing agent. Dicyandiamide-formaldehyde condensates were also discussed as possible replacements for cationic starch in sizing agents in U.S. Pat. No. 4,222,820 to Hiskens et al., and as replacements for cationic resins used in a size for ink jet recording paper by Miyamoto in U.S. Pat. No. 4,576,867. However, none of these publications suggests the use of these polyamines in combination with a wax and a poly(vinyl alcohol) for use to improve grease and/or water resistance as is done in the present invention.

Furthermore, in U.S. Pat. No. 5,423,911 to Coutelle et al. and U.S. Pat. No. 5,660,622 to Nikoloff, the use of dicyandiamide-formaldehyde condensates as in paper coatings is described as being undesirable for one reason or another.

In the present invention, combinations of poly(vinyl alcohol), wax, plasticizer, and optionally, a polyamine, are used in the second coating which provides the superior improvement in gas, water, water vapor and/or grease resistance and flexibility that has been described.

When the first treatment agent or the second coating include only poly(vinyl alcohol), wax, and plasticizer as the penetration-resistance controlling agents, the components can be used in any amounts. However, it is preferred that the ratio of the poly(vinyl alcohol) to the wax, by weight, is within a range of about 10:90 to about 90:10, a range of about 25:75 to about 75:25 is more preferred, a range of about 40:60 to about 60:40 is even more preferred, and a range of about 45:55 to about 55:45 is yet more preferred. In one embodiment, about 44% poly(vinyl alcohol) and about 56% wax, by weight, has been found to provide improved resistance.

When a polyamine is included in the second coating of the present invention, the poly(vinyl alcohol), the wax, the plasticizer, and the polyamine can each be included in almost any relative amount. However, it has been found to be preferred that the components be used in combinations in which the poly(vinyl alcohol) is within a range of about 3 to about 74% by wt. d.s. (where the dry solids (d.s.) include only the components of interest), the wax is within a range of about 13-96% by wt. d.s., and the polyamine is within a range of about 0.5-13% by wt. d.s. It is more preferred that the components be used in combinations In which the poly(vinyl alcohol) is within a range of about 22 to about 68%, by wt. d.s., the wax is within a range of about 25-74% by wt. d.s., and the polyamine is within a range of about 3-12% by wt. d.s. It is even mole preferred that the three components be used in combinations in which the poly(vinyl alcohol) is within a range of about 38 to about 68% by wt. d.s., the wax is within a range of about 25-55% by wt. d.s., and the polyamine is within a range of about 6-12% by wt. d.s. The preferred concentration of the plasticizer component is as discussed above.

Alternatively, it has been found that the present methods and compositions can be achieved with combinations of poly(vinyl alcohol), wax, and polyamine having a weight ratio of the three components, respectively, of about 4/5/1, or 5/4/1, or 4.5/4.5/1 before addition of the plasticizer.

In the present invention, the poly(vinyl alcohol), the wax, the plasticizer, and optionally the polyamine, can be intermixed into a composition that can be applied to the porous material to be treated. Alternatively, the components can be applied separately. If the components are administered separately, they can be administered at approximately the same time, or they can be administered at different times. By way of example, separate solutions or emulsions of each component can be administered to the material to be treated, or the solutions or emulsions can be intermixed and then applied to the material as a single composition.

The poly(vinyl alcohol), wax, plasticizer, and optionally, the polyamine, of the present invention can be present in the solutions, suspensions, dispersions, or emulsions, or in the compositions of the invention, in almost any concentration. It is preferred that the present compositions contain from about 0.5% to about 60% by weight dry substance, based only on the poly(vinyl alcohol), wax, plasticizer, and optional polyamine, more preferred that they contain from about 1% to about 50% by wt. d.s., and even more preferred that they contain from about 20% to about 40% by wt. d.s. The present compositions can be diluted prior to use, and after dilution, a d.s. of about 3% to about 10% would be typical, and from about 5% to about 8% d.s. would be preferred.

The wax/poly(vinyl alcohol)/plasticizer and optionally polyamine are applied in a sufficient amount so as to provide the level of performance desired, and that amount may vary widely according to the porous material and its characteristics, such as porosity and surface roughness, as well as the type and amount of the first treatment agent when one is used. The rheological characteristics of the wax/PVOH/plasticizer/optional polyamine coating composition, such as viscosity can also have an effect. When the wax/PVOH/plasticizer/optional polyamine compositions are applied to sheet material having a measurable surface area, such as paper, for example, typical use rates for the present invention, whether only poly(vinyl alcohol), wax, and plasticizer are used, or when a polyamine is also included, range from about 0.1 to about 4 lbs dry solids (d.s.) per 3000 ft² of surface of the material to be treated. It is preferred, however that the components be applied at a rate of between about 0.1 and about 3 lbs d.s./3000 ft², even more preferred is an application rate of between about 0.15 to about 2.0 lbs d.s./3000 ft², more preferred is an application rate of between about 0.15 and 1.0 lbs d.s./3000 ft², and yet more preferred is an application rate of between about 0.4 and 1.0 lbs d.s./3000 ft².

As mentioned above, materials other than the poly(vinyl alcohol), wax, plasticizer and optional polyamine can be used in the second treatment along with these ingredients without departing from the scope of the invention. It has been shown, for example, that it is often desirable to add an emulsifier along with the wax in order to form a stable aqueous emulsion. Other materials, such as colorants, dyes, preservatives, anti-fungal agents, surfactants, and the like, can also be used along with the wax, poly(vinyl alcohol), plasticizer, and optional polyamine in the present method.

Although it is possible, and even desirable, to provide and use the wax, the poly(vinyl alcohol) and the optional polyamine in aqueous solutions or emulsions, that is not required. In certain circumstances, for example, it might be useful to provide one or more of the components in an organic solvent, or in a molten form, or even in a dry form, such as a powder or flake.

The methods and compositions of the present invention can be used to treat materials of any sort that would benefit from an improvement in resistance to grease, or resistance to water, or both. The components of the present methods can be applied as coatings or in any other fashion at any point during the manufacture, packaging, storage, or use of the material to be treated.

When the present methods and compositions are used to form a coating, examples of materials to which they can be applied include packaging and non-packaging materials such as paper, cardboard, bakery board, butter and margarine chips, candy board, cup stock, frozen food containers, plate stock, artist's papers, asphalt laminations, carbonizing tissue, carton overwraps, cover and text papers, envelopes, garbage and trash bags, label papers, paper placemats, release papers, soap containers, wallpaper, liner board, folding cartons, multiwall bags, flexible packaging, duplicator and reproduction papers, support cards and medical dressings.

In addition, the present methods and compositions can be used to improve grease, oil, and moisture resistance of asphalt, wood, textile fabric, such as woven and non-woven fabrics, yarn, thread, carpets, upholstery, paperboard, formed articles, medical dressings, and the like.

Present materials to be treated may be porous, and therefore not impervious to gas, water, water vapor and grease, although such resistance may vary widely. The present porous materials are commonly in sheet form and include substrates comprised of non-woven and woven polymers such as fabrics, and cellulose-based materials, such as paper and cardboard substrates, and the like. As used herein, the terms “sheet material” refer to a material in a form that has length and width dimensions that are each significantly greater than the thickness of the material. Examples of sheet materials include paper, paperboard, housewrap, tarpaper, and the like. The amount of sheet materials can often be characterized in terms of surface area, and the dosage rate of material that is added to a sheet material can be expressed on the basis of the surface area of the material. An example of this type of measurement is a dosage rate expressed as lbs per ft², or pounds per unit area.

In a preferred embodiment, the paper comprises a porous sheet material made of a cellulosic material, or a cellulose-based material. Such paper sheet materials include, for example, corrugated paperboard (or “cardboard”), newsprint paper, uncorrugated Kraft paper stock, pan liner paper stock, and the like. In addition to paper and paper-like materials, other cellulose-based sheet materials, such as pressed board, may also be suitable. It is also possible to use other fibrous materials for the substrate sheet material.

As discussed above, the present invention can be used to improve the grease and/or water resistance of paper. When used to treat paper, the first treatment agent alone or along with the first treatment agent and the wax/poly(vinyl alcohol)/plasticizer and optional polyamine can be added to the wet end of a typical Fourdrinier machine, or they can be used to coat paper after it has been dried. Alternatively, the first treatment agent can be added to the wet end of a paper machine and the wax/poly(vinyl alcohol)/plasticizer and optional polyamine can be added as a coating to the paper at the dry end of the machine.

When the first treatment agent and/or the wax/poly(vinyl alcohol)/plasticizer and optional polyamine are used as a coating, particularly on paper, the components may be applied as a solution, emulsion, or dispersion, by roll coater, brush, doctor blade or blade coater, sprayer or other such suitable application means. Typically, the coated materials are dried after the wax/poly(vinyl alcohol)/plasticizer and optional polyamine has been applied.

After the application of the wax/poly(vinyl alcohol)/plasticizer and optional polyamine, further coatings or treatments may be applied to the material. Such coatings could include heat shielding coatings, UV-resistant coatings, coatings with specific chemical resistance, or the like

The coated material may be formed into a shaped article by means other than folding and gluing, such as, for example, by pressure-forming. Such shaped articles may be used for cooking or baking purposes. For example, the coated material may be used to make a container for storing food on a shelf (such as for storing pet food) while preventing penetration of grease, oil and/or water through the material. Or the coated material may be used to form a container such as a baking tray. Likewise, the coated material may be used to form a food receptacle such as a paper plate. Or the coated material may be used for fast-food containers, such as boxes for fried chicken, or food wrappers, such as wrapping materials for hamburgers and sandwiches. Thus, the coated material may be used for any of a variety of applications as a food container, wrapper or receptacle.

The following examples describe preferred embodiments of the invention. Other embodiments within the scope of the claims herein will be apparent to one skilled in the art from consideration of the specification of practice of the invention as disclosed herein. It is intended that the specification, together with the examples, be considered to be exemplary only, with the scope and spirit of the invention being indicated by the claims which follow the examples. In the examples all percentages are given on a weight basis unless otherwise indicated.

### EXAMPLE 1

Paper tests were run to determine the Flat Kit Value and the Fold Kit Value of five different coating compositions. In the coated paper tests described in Table 1 (below), a 10% solids coating was applied to a 20.5# base sheet using a Meyer Rod #1.5. Tests A-C were conducted according to the teachings of Dixit (U.S. Pat. No. 7,019,054) with polyvinyl alcohol and stearylated melamine in the ratios specified by Dixit. Test D shows the advantage of paraffin wax over stearylated melamine (Tests A-C), with higher Flat Kit tests seen at lower coating weights. Test E shows an improvement in the Fold Kit test when plasticizers are incorporated into the coating composition. Test E demonstrated both improved Flat Kit values and Fold Kit values over the Dixit compositions, even with lower coating weights.

TABLE 1
Flat Kit and Fold Kit values of coating compositions.

| | A | B | C | D | E |
|---|---|---|---|---|---|
| PVA:wax ratio | 0.95 | 0.5 | 2 | 0.53 | 0.82 |
| Wax | S/M | S/M | S/M | Paraffin | Paraffin |
| Polybutene | 0 | 0 | 0 | 0 | 40 |
| plasticizer (wt % | | | | | |
| based on wax) | | | | | |
| Coating weight (lbs | 0.58 | 0.58 | 1 | 0.3 | 0.3 |
| per 3000 ft²) | | | | | |
| Flat Kit Test | 5 | 5 | 6 | 7 | 7 |
| Fold Kit Test | <3 | <3 | 3 | <3 | 6 |

As can be seen in the tests above, the inclusion of a plasticizer in the present coating compositions increases the Fold Kit values while maintaining the Flat Kit Values of the coated materials. Moreover, by increasing the Fold Kit Values, the overall grease and water resistance of the coated materials is improved because the added flexibility from the inclusion of the plasticizer further strengthens the coating composition, preventing cracking and failure of the coating compositions when the coated material is folded, creased, or otherwise subjected to mechanical stresses.

### EXAMPLE 2

Blended emulsions of paraffin with styrene acrylic copolymer were prepared with added polybutenes. The amounts of polybutene and paraffin are expressed as a weight ratio, not including the styrene acrylic component. The styrene acrylic component was used at the same level In all blends. The blends were dried to a film, and these films were analyzed by differential scanning calorimetry (DSC). The initial softening temperature was noted, as the temperature of the initial inflection point on the curve where the softening transition occurs. These results (shown in tables 2 and 3) demonstrate that the Polybutenes A (Mₙ=370 gpc) and E (Mₙ=570 gpc) were capable of making a film with lower softening temperature than a comparable film using paraffin and styrene acrylic copolymer without polybutene. The lower softening temperature is an indicator of improved flexibility.

TABLE 2
Blends with Polybutene A:

| | | | Initial Softening |
|---|---|---|---|
| Blend | Polybutene (%) | Paraffin (%) | Temperature (° C.) |
| F | 0 | 100 | 28.0 |
| G | 20 | 80 | 21.6 |
| H | 30 | 70 | 13.6 |
| I | 40 | 60 | −3.4 |

TABLE 3
Blends with Polybutene B:

| | | | Initial Softening |
|---|---|---|---|
| Blend | Polybutene (%) | Paraffin (%) | Temperature (° C.) |
| F | 0 | 100 | 28.0 |
| J | 20 | 80 | 18.2 |

The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description shall be interpreted as illustrative and not in a limiting sense. In addition it should be understood that aspects of the various embodiments may be interchanged both in whole or in part.

1. A method of improving the gas, water, water vapor, or grease resistance of a material, the method comprising:
treating the material with wax, poly(vinyl alcohol), plasticizer, and optionally a polyamine, thereby improving the gas, water, water vapor, or grease resistance and flexibility of the material.

2. The method according to claim 1, further comprising the step of treating the material with a first treatment agent before the step of treating the material with wax, poly(vinyl alcohol), plasticizer, and optionally a polyamine.

3. The method according to claim 2, wherein the step of treating the material with the first treatment agent comprises applying the first treatment agent to a surface of the material to form a first coating.

4. The method according to claim 1, wherein the step of treating the material with wax, poly(vinyl alcohol), plasticizer, and optional polyamine comprises applying the wax, poly(vinyl alcohol), plasticizer, and optional polyamine over the first coating to form a wax/poly(vinyl alcohol)/plasticizer coating which optionally comprises a polyamine.

5. The method according to claim 1, wherein the step of treating the material with wax, poly(vinyl alcohol), plasticizer, and optional polyamine comprises applying the wax, poly(vinyl alcohol), plasticizer, and polyamine to form a wax/poly(vinyl alcohol)/plasticizer/polyamine coating.

6. The method according to claim 1, wherein improving the gas, water, water vapor, or grease resistance of the material comprises increasing the grease resistance of the material as measured by Flat Kit number and wherein the wax, poly(vinyl alcohol), plasticizer, and optional polyamine are applied in an amount sufficient to improve the grease resistance by at least 3 Flat Kit numbers.

7. The method according to claim 1, wherein improving the flexibility of the material comprises increasing the grease and/or water resistance of the material as measured by Fold Kit number and wherein the wax, poly(vinyl alcohol), plasticizer, and optional polyamine are applied in an amount sufficient to improve the grease and water resistance by at least 3 Fold Kit numbers.

8. The method according to claim 1, wherein the material comprises a porous material that is selected from the group consisting of paper, asphalt, asphalt laminations, wood, textile fabric, yarn, thread, formed articles and medical dressings.

9. The method according to claim 1, wherein the material comprises paper and is selected from the group consisting of cardboard, bakery board, butter chips, margarine chips, candy board, cup stock, frozen food containers, plate stock, artist's papers, carbonizing tissue, carton overwraps, cover paper, text paper, envelopes, garbage bags, trash bags, label papers, paper placemats, release papers, soap containers, wallpaper, liner board, folding cartons, multiwall bags, flexible packaging, duplicator paper, reproduction papers, medical dressings, and support cards.

10. The method according to claim 1, wherein the material comprises textile fabric and is selected from the group consisting of carpet, medical dressings, woven fabrics and non-woven fabrics.

11. The method according to claim 2, wherein the first treatment agent comprises a fluorochemical compound.

12. The method according to claim 2, wherein the first treatment agent comprises a polymer binder.

13. The method according to claim 12, wherein the polymer binder is selected from the group consisting of poly(vinyl alcohol), polyacrylate, polystyrene/polyacrylic copolymer, cellulose derivative, nitrocellulose, vinyl chloride, vinyl chloride copolymers, vinyl acrylate copolymers, vinyl acetate homopolymers, vinyl acetate copolymers, styrene butadiene polymers, styrene butadiene acrylonitrile polymers, polyvinylacetate, proteins, milk proteins, starch, and mixtures of any of these.

14. The method according to claim 2, wherein the first treatment agent comprises wax, poly(vinyl alcohol), plasticizer, and optionally a polyamine.

15. The method according to claim 2, wherein the first treatment agent comprises wax, poly(vinyl alcohol) and a polyamine.

16. The method according to claim 1, wherein the wax is an animal wax, a mineral wax, a vegetable wax, a synthetic wax or a mixture thereof

17. The method according to claim 16, wherein the wax is selected from the group consisting of paraffin wax, beeswax, bayberry-myrtle, candelilla, caranday, carnauba, castor bean wax, esparto grass wax, Japan wax, montan crude wax, ouricury, retamo-ceri nimbi, shellac wax, spermaceti, sugar cane wax, wool wax-lanolin, polyethylene wax, poly(ethylene-acrylate) wax, or a mixture of any two or more of these.

18. The method according to claim 1, wherein the poly(vinyl alcohol) is selected from the group consisting of super hydrolyzed poly(vinyl alcohol), full hydrolyzed poly(vinyl alcohol), intermediate hydrolyzed poly(vinyl alcohol), partially hydrolyzed poly(vinyl alcohol), and mixtures thereof.

19. The method according to claim 18, wherein the poly(vinyl alcohol) is intermediate hydrolyzed poly(vinyl alcohol) or partially hydrolyzed poly(vinyl alcohol).

20. The method according to claim 1, wherein the plasticizer is a polymeric and/or non-polymeric plasticizer.

21. The method according to claim 20, wherein the plasticizer is a polymeric plasticizer selected form the group consisting of polybutene, polyisobutylene, polybutene-1, polybutadiene, polyisoprene, and natural rubber latex.

22. The method according to claim 20, wherein the plasticizer is a homopolymer or copolymer made from one or more of butene, isoblutylene, butadiene, and isoprene.

23. The method according to claim 22, wherein the plasticizer is a copolymer having comonomers selected from one or more of styrene, acrylic acid, acrylamide, acrylonitrile, acrylate esters, ethylene, propylene, vinyl acetate, vinyl formamide, and cationic comonomers.

24. The method according to claim 1, wherein the step of treating the material comprises applying the poly(vinyl alcohol) and the wax to a sheet material at the combined rate of about 0.1 to about 3.0 lbs dry solids (d.s.) per 3000 ft² of surface of the material.

25. The method according to claim 1, wherein the step of treating the material comprises applying the poly(vinyl alcohol), wax, and the plasticizer to a sheet material at the combined rate of about 0.15 to about 2.0 lbs d.s./3000 ft² of surface of the material.

26. The method according to claim 1, wherein the step of treating the material comprises applying the poly(vinyl alcohol), the wax, and the plasticizer to a sheet material at the combined rate of about 0.15 to about 1.0 lbs d.s./3000 ft² of surface of the material.

27. The method according to claim 1, wherein the treatment comprises applying the poly(vinyl alcohol) and the wax to the material in a ratio of the poly(vinyl alcohol) to the wax, by weight, that is within a range of about 10:90 to about 90:10.

28. The method according to claim 1, wherein the treatment comprises applying the plasticizer to the material in a concentration of between about 10% and about 70% by weight based on the weight of the wax component.

29. The method according to claim 1, wherein the treatment comprises applying the plasticizer to the material in a concentration of between about 20% and about 50% by weight based on the weight of the wax component.

30. The method according to claim 1, wherein the polyamine, when present, comprises one or more of a polyoxyalkyleneamine, a polyoxyalkylenediamine, a polyoxyalkylenetriamine, or an amine-aldehyde condensate that is the reaction product of an amine containing an active hydrogen atom and an aldehyde.

31. The method according to claim 30, wherein the polyamine comprises a polyoxyalkyleneamine, a polyoxyalkylenediamine, a polyoxyalkylenetriamine, a dicyandiamide-formaldehyde condensate, or a mixture thereof.

32. A porous material that has been treated by the method according to claim 1.

33. A porous material having a Fold Kit value greater than about 4.

34. The porous material according to claim 33, wherein the porous material is selected from one or more of paper, asphalt, asphalt laminations, wood, textile fabric, yarn, thread, formed articles and medical dressings.

35. The method according to claim 33, wherein the material comprises paper and is selected from the group consisting of cardboard, bakery board, butter chips, margarine chips, candy board, cup stock, frozen food containers, plate stock, artist's papers, carbonizing tissue, carton overwraps, cover paper, text paper, envelopes, garbage bags, trash bags, label papers, paper placemats, release papers, soap containers, wallpaper, liner board, folding cartons, multiwall bags, flexible packaging, duplicator paper, reproduction papers, medical dressings, and support cards.

36. The method according to claim 33, wherein the material comprises textile fabric and is selected from the group consisting of carpet, medical dressings, woven fabrics and non-woven fabrics.

37. A porous material having improved gas, water, water, vapor and/or grease resistance and improved flexibility comprising the porous material having a surface on which is a first coating of a first treatment agent and a second coating comprising wax, poly(vinyl alcohol), plasticizer, and optionally a polyamine over the first coating.

38. A composition for improving the gas, water, water vapor, or grease resistance of a material, the composition comprising wax, poly (vinyl alcohol), plasticizer, and optionally a polyamine.

39. A composition for improving the gas, water, water vapor, or grease resistance of a material, the composition comprising wax, poly (vinyl alcohol), plasticizer, and a polyamine.

40. The composition according to claim 38, wherein said wax is an animal wax, a mineral wax, a vegetable wax, a synthetic wax, or a mixture thereof.

41. The composition according to claim 40, wherein said wax is selected from the group consisting of paraffin wax, beeswax, bayberry-myrtle, candelilla, caranday, carnauba, castor bean wax, esparto grass wax, Japan wax, montan crude wax, ouricury, retamo-ceri nimbi, shellac wax, spermaceti, sugar cane wax, wool wax-lanolin, polyethylene wax, poly(ethylene-acrylate) wax, and combinations thereof.

42. The composition according to claim 38, wherein the poly(vinyl alcohol) is selected from the group consisting of super hydrolyzed poly(vinyl alcohol), fully hydrolyzed poly(vinyl alcohol), intermediate hydrolyzed poly(vinyl alcohol), partially hydrolyzed poly(vinyl alcohol), and mixtures thereof.

43. The composition according to claim 38, wherein the plasticizer is a polymeric and/or non-polymeric plasticizer.

44. The composition according to claim 43, wherein the plasticizer is a polymeric plasticizer selected form the group consisting of polybutene, polyisobutylene, polybutene-1, polybutadiene, polyisoprene, and natural rubber latex.

45. The composition according to claim 43, wherein the plasticizer is a homopolymer or copolymer made from one or more of butene, isobutylene, butadiene, and isoprene.

46. The composition according to claim 43, wherein the plasticizer is a copolymer having comonomers selected from one or more of styrene, acrylic acid, acrylamide, acrylonitrile, acrylate esters, ethylene, propylene, vinyl acetate, vinyl formamide, and cationic comonomers.

47. The composition according to claim 39, wherein the polyamine is selected from the group consisting of polyoxyalkyleneamine, polyoxyalkylenediamine, polyoxyalkylenetriamine, an amine-aldehyde condensate that is the reaction product of an amine containing an active hydrogen atom and an aldehyde, and combinations thereof.

48. A material having improved gas, water, water vapor arid/or grease resistance and flexibility comprising a material having a composition according to claim 38 applied as a coating.

49. A material having improved gas, water, water vapor and/or grease resistance and flexibility a comprising a material having a composition according to claim 39 applied as a coating.
